(19) United States
(12) Patent Application Publication
(10) Pub. No.: US 2005/0224354 A1
(43) Pub. Date: Oct. 13, 2005

(54) Separation process and dyes for use therewith

(76) Inventors: Peter Jackson, Cambridge (GB); Mark N. Bobrow, Lexington, MA (US); Joseph D. Trometer, Framingham, MA (US)

Correspondence Address: GIFFORD, KRASS, GROH, SPRINKLE, ANDERSON;& CITKOWSKI, P.C., 280 N. OLD WOODWARD AVE., SUITE 400, BIRMINGHAM, MI, 48009, US

(21) Appl. No.: 10/513,732

(22) PCT Filed: May 6, 2003
(86) PCT No.: PCT/US03/14476

§ 371 Date: Jun. 3, 2005

(30) Foreign Application Priority Data
May 6, 2002 (US) 60380085

(51) Int. Cl. G01N 27/453

(52) U.S. Cl. 204/456

(57) ABSTRACT

The present invention describes rhodamine compounds particularly well-suited for pre-labeling a protein that is then subjected to two-dimensional electrophoresis. Isomeric purification and synthesis of a dye having net neutral charge or no charge precludes interference with isoelectric electrophoretic separation.

### RELATED APPLICATION

This application claims priority of U.S. Provisional Patent Application No. 60/380,085 filed May 6, 2002, which is incorporated herein by reference.

### FIELD OF THE INVENTION

This invention relates in general to separation science and in particular, to compounds and processes for pre-labeling a protein or mixture of proteins before electrophoresis or membrane separation.

### BACKGROUND OF THE INVENTION

Two-dimensional electrophoresis is commonly utilized for the separation of complex protein mixtures. The resolution of the specific protein mixture components based on two separate characteristics affords considerable flexibility and the ability to efficiently isolate individual protein components from a protein mixture. Conventional electrophoretic separation characteristics include charge-based separation followed by molecular weight-based separation; and separation of a first gel concentration followed by separation in a second gel concentration. Additionally, an electrophoretic gel is routinely constructed having a gradient that varies in the direction of separation with respect to aspects such as pH, pore size, protein solubilizer concentration and buffer. With the wide range of variables available to perform separations, many types of biologically relevant mixtures are routinely separated including cellular proteins, bacterial proteins, ribosomal proteins, nucleic acids, mixtures of ribonucleic proteins and ribosomal proteins, and serum proteins.

Conjugation of biological molecules such as proteins and nucleic acids to dye molecules is regularly accomplished in order to impart light absorption and fluorescence to the subject molecule. Dye conjugation facilitates visualization and fluorescence imaging. A fluorescent dye operative in two-dimensional electrophoresis should have the properties of linking in a controlled matter to a subject molecule, have a known charge, fluoresce brightly and yield a distinct spot pattern. Similar properties are required for membrane separations.

Common protein conjugating dyes for amine reactive protein labeling are a sulfonyl halide derivative of rhodamine known as sulforhodamine 101, and sulforhodamine B-type dyes. While conventional sulforhodamine dyes are generally considered to have acceptable quantum yields and form good spot patterns, other characteristics of conventional sulforhodamine dyes have limited the effectiveness of these dyes in two-dimensional electrophoresis. Sulforhodamine 101 acid chloride has a sulfonyl halide group that is highly reactive and, therefore, readily hydrolyzed prior to protein conjugation. Additionally, the reactivity of the sulfonyl group means that not only are target amine groups within proteins labeled, but through competitive reaction pathways observer species, such as those found in gel media and buffer systems, are inadvertently labeled thereby increasing fluorescence background in diffusing electrophoretic spots. The high reactivity of the sulfonyl halide group of conventional sulforhodamine dyes also means that there is poor kinetic control over the labeling process and, therefore, variables such as mixing rate, temperature, spectator species identity and the like affect the labeling process.

The use of sulforhodamine dyes in two-dimensional electrophoresis has also been limited by the charge characteristics of the dye that create a net charge that interferes with separation based upon inherent charge of a conjugated protein within a protein mixture. Additionally, commercial sources of sulforhodamine 101 typically contain a mixture of isomers at the two and four positions between sulfonyl chloride and sulfonate. The addition of an alkyl spacer to the sulfonyl chloride has been shown to yield a dye that is more stable and more fluorescent than the base sulforhodamine 101. U.S. Pat. No. 5,798,276 details the use of such a linker. However, there still exists a need for a dye having superior sensitivity, isomeric purity and the ability to clear excess dye during the course of isoelectric electrophoretic focusing to further enhance protein imaging through two-dimensional protein gel electrophoresis.

### SUMMARY OF THE INVENTION

A separation, such as by two-dimensional electrophoresis or membrane separation, is performed by a process including pre-labeling a mixture containing at least one protein with a dye having a neutral charge or no charge. The protein is pre-labeled by coupling to a protein linker group of the dye to form a pre-labeled protein. The pre-labeled protein is separated from the mixture under two-dimensional electrophoretic conditions. A dye active in the process is: 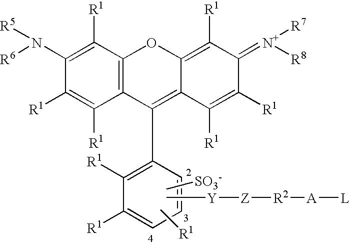
where Y is sulfonyl halide, SO₂—, or a nullity; Z is NR³— or a nullity; where each occurrence of R¹ independently is hydrogen, C₁-C₃₀ alkyl group, a C₀-C₄ alkyl group having a substituent selected from a group consisting of sulfonate, hydroxyl, sulfhydryl, substituted amine and quaternary amine and any two proximal R¹ or R¹ with one of R⁵, R⁶, R⁷ or R⁸ groups are fused to form a ring structure, the ring structure optionally having a heteroatom therein and having pendant groups extending therefrom, the pendant groups each independently selected from hydrogen, C₁-C₈ alkyl, a C₀-C₄ alkyl group having a substituent selected from a group consisting of sulfonate, hydroxyl, sulfhydryl, substituted amine and quaternary amine; where R³ is H, a monocyclic aliphatic hydrocarbon, a carbohydrate, C₁-C₆ alkyl or C₁-C₆ acyl; R² is a nullity, a monocyclic aliphatic hydrocarbon, a carbohydrate, an aryl, an alkyl chain of the form (CH₂)ₘ where m is an integer inclusively between 1 and 12, a polyalkylene glycol chain of the form R⁴((CH₂)ₙO)ₒR⁴ where n is an integer inclusively between 1 and 6, where o is an integer inclusively between 1 and 4, where each occurrence of R⁴ independently is C₁-C₆ alkyl or a nullity, and inert substituent containing derivatives of R² where the inert substituent is selected from a group consisting of C₁-C₆ alkyl, carbonyl, amine and sulfhydryl, or a nullity all, where A is NR³— or a nullity where at least one of the groups Y, Z, R² and A is other than the nullity, where each of R⁵, R⁶, R⁷ and R⁸ independently is H or C₁-C₆ alkyl, and where L is a protein linker group.

An inventive compound has the formula 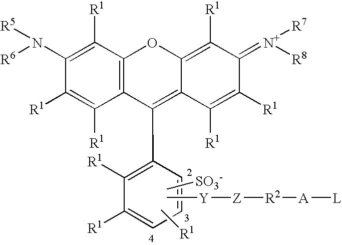
where Y is SO₂—, where Z is NR³—, where each occurrence of R¹ independently is hydrogen, C₁-C₃₀ alkyl group, a C₀-C₄ alkyl group having a substituent selected from a group consisting of sulfonate, hydroxyl, sulfhydryl, substituted amine and quaternary amine and any two proximal R¹ or R¹ and one of R⁵, R⁶, R⁷ or R⁸ groups are fused to form a ring structure, the ring structure optionally having a heteroatom therein and having pendant groups extending therefrom, the pendant groups each independently selected from hydrogen, C₁-C₈ alkyl, a C₀-C₄ alkyl group having a substituent selected from a group consisting of sulfonate, hydroxyl, sulfhydryl, substituted amine and quaternary amine; where R³ is H, a monocyclic aliphatic hydrocarbon, a carbohydrate, C₁-C₆ alkyl or C₁-C₆ acyl, where R² is a nullity, a monocyclic aliphatic hydrocarbon, a carbohydrate, a polyalkylene glycol chain of the form R⁴((CH₂)ₙO)ₒR⁴ where n is an integer inclusively between 1 and 6, where o is an integer inclusively between 1 and 4, where each occurrence of R⁴ independently is C₁-C₆ alkyl or a nullity, and inert substituent containing derivatives of R² where the inert substituent is selected from a group consisting of C₁-C₆ alkyl, carbonyl, amine and sulfhydryl, where A is NR³—, or a nullity where at least one of the groups Y, Z, R² and A is other than the nullity, where each of R⁵, R⁶, R⁷ and R⁸ independently is H or C₁-C₆ alkyl, and where L is a protein linker group.

These compounds are useful for labeling proteins. Pre-labeling of a protein prior to performing two-dimensional electrophoresis or a membrane separation is a particular utility of an inventive compound. Isomeric purification of a dye useful in pre-labeling a protein that is then subjected to two-dimensional protein electrophoresis or a membrane separation represents an improvement over the prior art. A commercial package containing an inventive compound is an active ingredient is disclosed together with instructions for the use thereof as a protein labeling dye.

### BRIEF DESCRIPTION OF THE DRAWINGS

FIG. 1 is a reaction scheme for the synthesis of inventive sulforhodamine B dyes;

FIG. 2 is a reactive scheme for the synthesis of inventive sulforhodamine 101 dyes;

FIG. 3 is a 1D electrophoretic gel showing the isomeric fluorescence intensity differences; and

FIG. 4 is a 2D electrophoretic gel showing a yeast lysate protein spot image according to the present invention.

### DETAILED DESCRIPTION OF THE PREFERRED EMBODIMENTS

The present invention is generally applicable to any two-dimensional separation and finds greatest utility in procedures involving an initial charge-based separation such as the isoelectric focusing strip or gel, and another separation in a second dimension, such as a polyacrylamide slab gel. The present invention is equally applicable to membrane separations in aqueous and non-aqueous solvent systems. It is appreciated that the first dimension of a separation, for example, is a dry or swollen native gel, a gel containing a carrier ampholyte, detergent or other protein denaturing agent such as urea. The second dimension, for example, can be a membrane or a gel and buffer system specifically formulated for the separation of protein that includes, for example, a fixed or gradient concentration of polyacrylamide and a denaturing agent.

An inventive process for performing a separation such as two-dimensional protein electrophoresis or membrane separation that involves pre-labeling a protein with a dye having a neutral charge and that, for example, contains an equal number of quaternary amine and free sulfonate groups, an equal number of any positively and negatively charged groups, or a dye containing no charged groups. As used herein “pre-labeling” is intended to mean the formation of a covalent linkage between the dye and a subject molecule prior to initiation of an electrophoretic separation procedure.

According to the present invention a pre-labeled protein is then separated from a proteinaceous mixture under two-dimensional electrophoretic conditions. The inventive process of pre-labeling proteins is particularly well-suited for charge-based separations as the inventive dyes are charge neutral and yield well-defined protein spot patterns. Alternately, the first dimension separation may be completed by separating proteins that have not been pre-labeled and the proteins labeled subsequently, whilst within the first dimension separation matrix prior to the second dimension separation.

Broadly, an inventive dye has characteristics that include a net neutral or no charge, where a net neutral charge is created, for example, by having an equal number of quaternary amine and free sulfonate moieties within the dye structure, or within the dye and linking group to the protein. Preferably, the dye has significant fluorescence associated with a conjugated polyaromatic ring structure. Additionally, the dye may contain a moiety which is cleavable. The cleavable moiety enables the chemical or enzymatic separation of the protein or peptide from the dye after recovery from the gel. Where the first dimension of a two-dimensional electrophoresis system is an isoelectric focusing separation, dye otherwise not pre-labeling a protein is cleared from the separation matrix, either partially, completely or substantially, either prior to performing electrophoretic separation or along the first or second dimension by way of a mop-up reagent.

A “mop-up” reagent as used herein is defined to include those substances that adsorb, degrade, immobilize, bind to or otherwise change the physical properties, such as charge, of a dye molecule that is not bound to a protein.

A mop-up reagent operative herein illustratively includes Tris[2-carboxyethyl]phosphine (TCEP), immobilized TCEP, Cys-Arg-Arg, Arg-Ser-Arg-Ser-Arg-Cys, Tris[N-ethylsulfonic acid 3-propionamide]phosphine, 2-mercaptoethanesulfonic acid, 2-mercaptoethylamine and 2-dimethylaminoethanethiol.

A dye of the present invention has the general formula 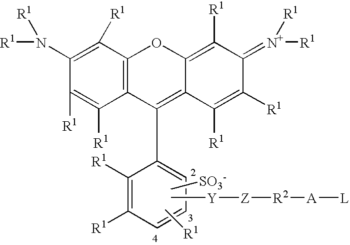
wherein Y is sulfonyl halide, SO₂—, or a nullity; Z is NR³— or a nullity; wherein each occurrence of R¹ independently is hydrogen, C₁-C₃₀ alkyl group, a C₀-C₄ alkyl group having a substituent selected from a group consisting of sulfonate, hydroxyl, sulfhydryl, substituted amine and quaternary amine and any two proximal R¹ groups are fused to form a ring structure, the ring structure optionally having a heteroatom therein and having pendant groups extending therefrom, the pendant groups each independently selected from hydrogen, C₁-C₈ allyl, a C₀-C₄ alkyl group having a substituent selected from a group consisting of sulfonate, hydroxyl, sulfhydryl, substituted amine and quaternary amine; wherein R³ is H, a monocyclic aliphatic hydrocarbon, a carbohydrate, C₁-C₆ alkyl or C₁-C₆ acyl; R² is a nullity, a monocyclic aliphatic hydrocarbon, a carbohydrate, an aryl, an alkyl chain of the form (CH₂)ₘ wherein m is an integer inclusively between 1 and 12, a polyalkylene glycol chain of the form R⁴((CH₂)ₙO)ₒR⁴ wherein n is an integer inclusively between 1 and 6, wherein o is an integer inclusively between 1 and 4, wherein each occurrence of R⁴ independently is C₁-C₆ alkyl or a nullity, and inert substituent containing derivatives of R² wherein the inert substituent is selected from a group consisting of C₁-C₆ alkyl, carbonyl, amine and sulfhydryl, or a nullity all, wherein A is NR³— or a nullity wherein at least one of the groups Y, Z, R² and A is other than the nullity, wherein at least one of the groups Z, R², R³ and A optionally contains a moiety which is chemically or enzymatically cleavable such as a vicinal diol or a polyvicinal diol chain of the form R⁴((CH(OH)CH(OH))ₙR⁴ wherein n is an integer inclusively between 1 and 6, wherein each occurrence of R⁴ independently is C₁-C₆ alkyl or a nullity, or a peptide having a protease recognition site and wherein L is a protein linker group. Alternatively, a reactive dye of the present invention has the general formula 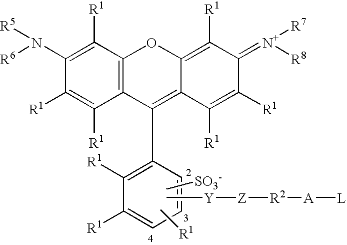
wherein Y is sulfonyl halide, SO₂—, or a nullity; Z is NR³— or a nullity; wherein each occurrence of R¹ independently is hydrogen, C₁-C₃₀ alkyl group, a C₀-C₄ alkyl group having a substituent selected from a group consisting of sulfonate, hydroxyl, sulfhydryl, substituted amine and quaternary amine and any two proximal R¹ or R¹ with one of R⁵, R⁶, R⁷ or R⁸ groups are fused to form a ring structure, the ring structure optionally having a heteroatom therein and having pendant groups extending therefrom, the pendant groups each independently selected from hydrogen, C₁-C₈ alkyl, a C₀-C₄ alkyl group having a substituent selected from a group consisting of sulfonate, hydroxyl, sulfhydryl, substituted amine and quaternary amine; wherein R³ is H, a monocyclic aliphatic hydrocarbon, a carbohydrate, C₁-C₆ alkyl or C₁-C₆ acyl; R² is a nullity, a monocyclic aliphatic hydrocarbon, a carbohydrate, an aryl, an alkyl chain of the form (CH₂)ₘ wherein m is an integer inclusively between 1 and 12, a polyalkylene glycol chain of the form R⁴((CH₂)ₙO)ₒR⁴ wherein n is an integer inclusively between 1 and 6, wherein o is an integer inclusively between 1 and 4, wherein each occurrence of R⁴ independently is C₁-C₆ alkyl or a nullity, and inert substituent containing derivatives of R² wherein the inert substituent is selected from a group consisting of C₁-C₆ alkyl, carbonyl, amine and sulfhydryl, or a nullity all, wherein A is NR³— or a nullity wherein at least one of the groups Y, Z, R² and A is other than the nullity, wherein at least one of the groups Z, R², R³ and A optionally has a moiety which is chemically or enzymatically cleavable such as a vicinal diol or a protease recognition site where each of R⁵, R⁶, R⁷ and R⁸ independently is H or C₁-C₆ alkyl, and where L is a protein linker group.

With respect to dyes according to both Formula I and II, the protein linker group L is preferably an electrophilic moiety capable of covalently bonding to a peptide moiety. A peptide moiety as used herein is intended to mean a moiety extending from a polypeptide, the moiety being naturally occurring or synthetic, where a synthetic peptide is either an α or β amino acid. The protein linker L according to the present invention illustratively includes acid halide, C₁-C₁₂ ester, acyl azide, haloacetamide, maleimide, maleimidyl benzamide, maleimidyl C₁-C₅ alkyl amido, azido benzamido, azido perfluorobenzamido, and where a halide or halo moiety is Cl, Br or I. A maleimide or haloacetamide, or more specifically iodoacetamide or bromoacetamide, represent a preferred chemical linker L.

In preparing a dye of the present invention for performing two-dimensional protein electrophoresis, it is often the case that there is isomerization within the phenyl ring derivatized with a free sulfonate in a chain terminating the chemical linker L. This is especially the case where Y constitutes a sulfonic acid or sulfonyl chloride group in a precursor to an inventive dye. In a preferred embodiment of the present invention, it has been surprisingly discovered that having the chemical linker L extending from the two position of the reactive dye often has considerably different properties under two-dimensional electrophoretic separation conditions, as compared to a chemical linker L extending from the four position of the inventive dye formulae. As a result, it is preferred that the inventive process for performing two-dimensional protein electrophoresis utilizes an isomerically purified dye. It is appreciated that similar isomeric differences are to be noted in the phenyl rings substituted at the two and three positions in a manner similar to that detailed above with respect to position two and position four substituted dyes. While the differences in electrophoretic performance of various dye isomers in pre-labeling proteins according to the present invention is not fully understood, the relative efficacy of the various isomers is readily determined following isomeric separation by conventional means through the parallel testing of the various purified isomers in a controlled electrophoretic experiment. It is appreciated that isomeric variations associated with the polycyclic portion of an inventive dye structure may modify the dye properties under electrophoretic conditions upon protein labeling.

The present invention also includes novel dye structures that demonstrate superior performance under two-dimensional electrophoretic separation conditions, as compared to conventional dyes. An inventive compound according to the present invention has the general formula 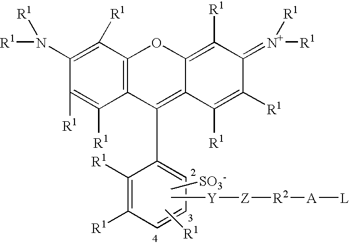
or the general formula 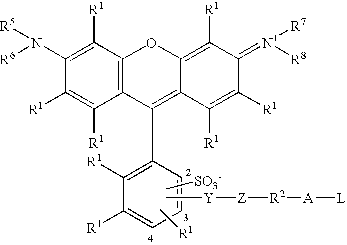
where Y is SO₂—, where Z is NR³—, where each occurrence of R¹ independently is hydrogen, C₁-C₃₀ alkyl group, a C₀-C₄ alkyl group having a substituent selected from a group consisting of sulfonate, hydroxyl, sulfhydryl, substituted amine and quaternary amine and any two proximal R¹ groups are fused to form a ring structure, the ring structure optionally having a heteroatom therein and having pendant groups extending therefrom, the pendant groups each independently selected from hydrogen, C₁-C₈ alkyl, a C₀-C₄ alkyl group having a substituent selected from a group consisting of sulfonate, hydroxyl, sulfhydryl, substituted amine and quaternary amine; where R² is a nullity, H, C₁-C₆ alkyl or C₁-C₆ acyl, where R² is a polyalkylene glycol chain of the form R⁴((CH₂)ₙO)ₒR⁴ where n is an integer inclusively between 1 and 6, where o is an integer inclusively between 1 and 4, where each occurrence of R⁴ independently is C₁-C₆ alkyl or a nullity, and inert substituent containing derivatives of R² where the inert substituent is selected from a group consisting of C₁-C₆ alkyl, carbonyl, amine and sulfhydryl, where A is NR³—, or a nullity where at least one of the groups Y, Z, R² and A is other than the nullity, where each of R⁵, R⁶, R⁷ and R⁸ independently is H or C₁-C₆ alkyl, and where L is a protein linker group. With respect to the novel compounds of the present invention, the protein linker group L is that as described above. Preferably, R² is R₄(CH₂CH₂O)ₙR₄. A particularly preferred embodiment of R² is CH₂(CH₂CH₂O)ₙ(CH₂)₃

In order to more fully demonstrate the advantages arising from the present invention, the following examples are set forth. It is to be understood that the following is by way of example only and not intended as a limitation on the scope of the invention.

### EXAMPLE 1

### Sulforhodamine B (a) 2-, (b) 4-, and (c) 2,4-bis sulfonamide-dPEG3-bromoacetamide dye synthesis

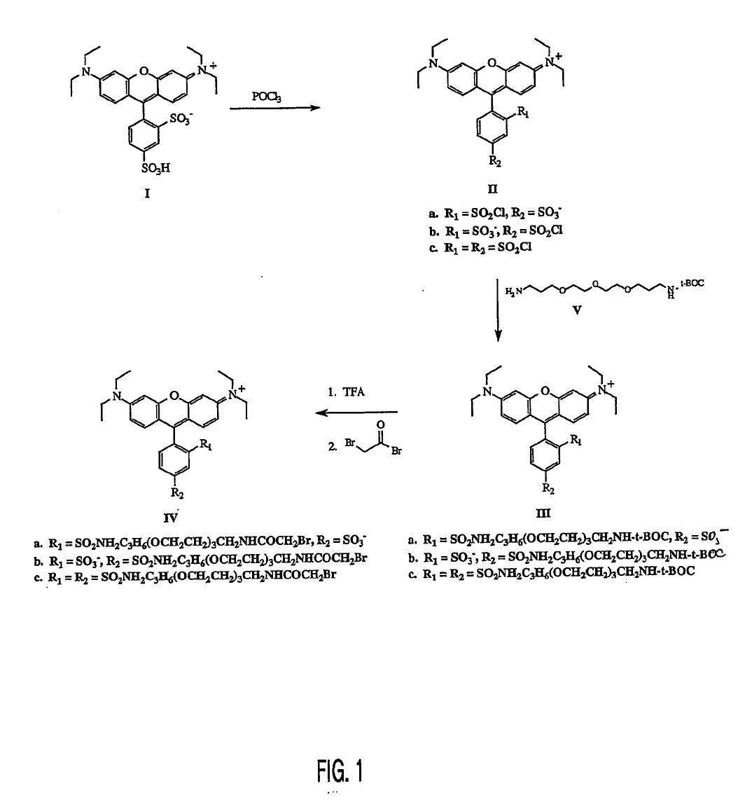

As shown in FIG. 1, to a 25 mL round bottom flask is added a magnetic stir bar and 1.0 g (1.8 mmol) of Sulforhodamine B (1). To this solid is added 4.0 mL (42.9 mmol) of phosphorus oxychloride. A drying tube is added to the flask and the reaction mixture is allowed to stir at room temperature for 18 h. The reaction mixture is carefully poured over 50 g of ice and stirred for 15 min. The aqueous solution is extracted with chloroform (3×50 mL). The combined organic phases are washed with ice cold water (3×50 mL). The organic phase is dried over sodium sulfate and filtered into a 250 mL round bottom flask to afford a dark blue solution of Sulfonylchloride substituents (II) on the phenyl ring having (a) 2 position sulfonyl chloride—4 position sulfonate; (b) 2 position sulfonate—4 position sulfonyl chloride; and (c) both 2 and 4 position sulfonyl chlorides.

The reaction flask is fitted with a pressure equalized addition funnel and the chloroform solution is cooled to 0° C. To the cooled reaction mixture is added a solution of 500 mg (1.56 mmol) of mono-N-t-boc-amido-dPEG3-amine (V) and 1.0 mL of Triethylamine in 30 mL chloroform over 25 min. The reaction mixture is allowed to warm to room temperature and stir an additional 18 h. The reaction mixture is washed with water (3×75 mL) and the organic phase is dried over sodium sulfate. The dark red solution is filtered and the solvents are removed under reduced pressure to afford a mixture of sulfonamide-dPEG3-amido-t-BOCs (III) formed from each of the sulfonyl chlorides of (a)-(c).

Sulfonamides (III) are dissolved in 40 mL of acetonitrile. To this dark red mixture is added 40 mL of a 50% trifluoroacteic acid in water solution. The resulting solution is stirred at room temperature for 18 h. The solvents are removed under reduced pressure and the residue is taken up into 150 mL of chloroform. The solution is dried over sodium sulfate and filtered. To this solution is added with stirring 7.0 mL (40 mmol) of diisopropylethylamine. After 5 min, 3.0 mL (34 mmol) of bromoacetylbromide is added and this solution is protected from the light and stirred at room temperature for 2 h. The reaction mixture is diluted with 100 mL of chloroform and washed with water (3×100 mL). The organic phase is dried over sodium sulfate, filtered and concentrated to afford a crude mixture of sulfonamide-dPEG3-amino acetyl bromides (IV) formed from each of the sulfonamide-dPEG3-amido-t-BOCs per (a)-(c). The products are purified by flash chromatography to afford Sulfonamides (IV) as dark red solids.

### EXAMPLE 2

### Sulforhodamine 101 (a) 2-, (b) 4-, and (c) 2,4-bis-sulfonoamide-dPEG3-bromoacetamide synthesis

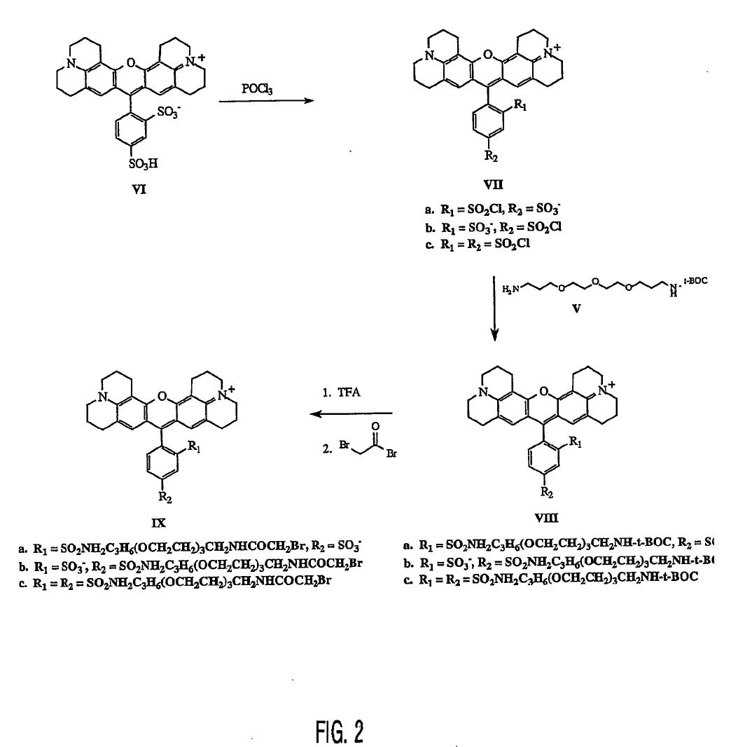

As shown in FIG. 2, to a 25 mL round bottom flask is added a magnetic stir bar and 1.0 g (1.65 mmol) of Sulforhodamine 101 (VI). To this solid is added 4.0 mL (42.9 mmol) of phosphorus oxychloride. A drying tube is added to the flask and the reaction mixture is allowed to stir at room temperature for 18 h. The reaction mixture is carefully poured over 50 g of ice and stirred for 15 min. The aqueous solution is extracted with chloroform (3×50 mL). The combined organic phases are washed with ice cold water (3×50 mL). The organic phase is dried over sodium sulfate and filtered into a 250 mL round bottom flask to afford a dark blue solution of Sulfonylchloride substituents (VII) on the phenyl ring having (a) 2 position sulfonyl chloride —4 position sulfonate; (b) 2 position sulfonate —4 position sulfonyl chloride; and (c) both 2 and 4 position sulfonyl chlorides.

The reaction flask is fitted with a pressure equalized addition funnel and the chloroform solution is cooled to 0° C. To the cooled reaction mixture is added a solution of 500 mg (1.56 mmol) of mono-N-t-boc-amido-dPEG3-amine (V) and 1.0 mL of Triethylamine in 30 mL chloroform over 25 min. The reaction mixture is allowed to warm to room temperature and stir an additional 18 h. The reaction mixture is washed with water (3×75 mL) and the organic phase is dried over sodium sulfate. The dark red solution is filtered and the solvents are removed under reduced pressure to afford a mixture of sulfonamide-dPEG3-amido-t-BOCs (VIII) formed from each of the sulfonyl chlorides of (a)-(c).

Sulfonamides (VIII) are dissolved in 40 mL of acetonitrile. To this dark red mixture is added 40 mL of a 50% trifluoroacteic acid in water solution. The resulting solution is stirred at room temperature for 18 h. The solvents are removed under reduced pressure and the residue is taken up into 150 mL of chloroform. The solution is dried over sodium sulfate and filtered. To this solution is added with stirring 7.0 mL (40 mmol) of diisopropylethylamine. After 5 min, 3.0 mL (34 mmol) of bromoacetylbromide is added and this solution is protected from the light and stirred at room temperature for 2 h. The reaction mixture is diluted with 100 mL of chloroform and washed with water (3×100 mL). The organic phase is dried over sodium sulfate, filtered and concentrated to afford a crude mixture of sulfonamide-dPEG3-amino acetyl bromides (X) formed from each of the sulfonamide-dPEG3-amido-t-BOCs per (a)-(c). The products are purified by flash chromatography to afford Sulfonamides ([X) as dark red solids.

### EXAMPLES 3-10

### Additional Inventive Sulforhodamine 101

The procedures of Example 1 are repeated with an equimolar amount of H₂NR⁸N-t-BOC replacing mono-N-t-boc-amido-dPEG3-amine and R⁹X replacing BrCH₂C(O)Br. The results are summarized in Table 1.

### EXAMPLES 11-18

The procedures of Example 2 are repeated with an equimolar amount of H₂NR⁸N-t-boc replacing mono-N-t-boc-amido-dPEG3-amine and R⁹X replacing BrCH₂C(O)Br. The results are summarized in Table 1.

TABLE 1

| Examples | R⁸ | R⁸X | YZR¹AL |
|---|---|---|---|
| 3/11 | CH₂(CH₂CH₂O)₂(CH₂)₃ | N-(4-bromoethyl)phthalimide | 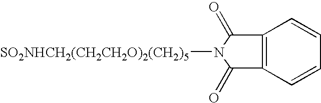 |
| 4/12 | CH₂(CH₂CH₂O)₂(CH₂)₃ | 4 bromobutyrlchloride | SO₂NHCH₂(CH₂CH₂O)₂(CH₂)₆C(O)Cl |
| 5/13 | CH₂(CH₂CH₂O)₂(CH₂)₃ | 4 bromobenzoic hydrazide | SO₂NHCH₂(CH₂CH₂O)₂(CH₂)₃C₆H₄C(O)NHNH₂ |
| 6/14 | CH₂(CH₂CH₂O)₂(CH₂)₃ | 4 bromobenzene sulfonyl chloride | SO₂NHCH₂(CH₂CH₂O)₂(CH₂)₃C₆H₄SO₂Cl |
| 7/15 | CH₂(CH₂CH₂O)₂(CH₂)₃ | N-bromophthalimide | 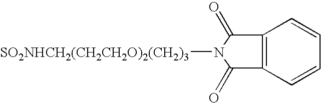 |
| 8/16 | CH₂(CH₂CH₂O)₂(CH₂)₃ | N-bromomaleimide | 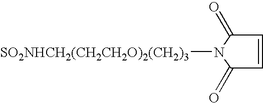 |
| 9/17 | CH₂(CH₂CH₂O)₂(CH₂)₃ | 2-chloro-1-ethane sulfonyl chloride | SO₂NHCH₂(CH₂CH₂O)₂(CH₂)₅—SO₂Cl |
| 10/18 | CH₂(CH₂CH₂O)₂(CH₂)₃ | 3 chloro-1 propane thiol | SO₂NHCH₂(CH₂CH₂O)₂(CH₂)₆—SH |

### EXAMPLE 19

### Purification of sulforhodamine 101 (a) 2-, (b) 4-, and (c) 2,4-bis sulfonamide-dPEG3-bromoacetamide

Sulfonamides (IX a-c) are dissolved in a minimum volume of chloroform and loaded onto a silica gel column (Flash Grade, ˜20 wt. Equivalence). The substrates are eluted with a chloroform/methanol gradient and the eluents are collected in fractions. The fractions corresponding to product are combined and the solvents are removed under reduced pressure to afford dark red solids.

### EXAMPLE 20

### Labeling of a protein mixture with isomerically purified sulforhodamine B (a) 2-, and (b) 4-sulfonoamide-dPEG3-bromoacetamide

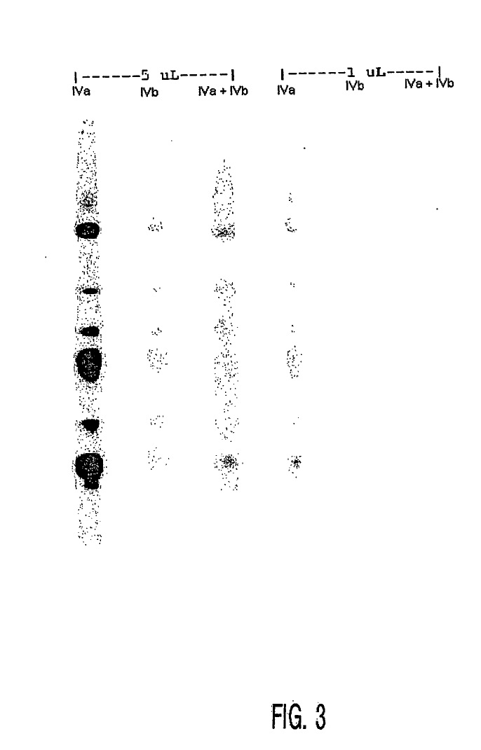

Sigma Mark VII (SDS7) marker proteins (Sigma, St. Louis, Mo.) are prepared as follows. To the dry protein in the vial is added 400 μL 9.0 M urea, 50 mM Na acetate buffer, pH 5.0 at 23° C., 10 mM EDTA Na₂ and allowed to wet. After 10 min. 40 μL 20% (w/v) CHAPS, 8.25 M urea is added, and mixed well to dissolve the proteins. Ten microliters of this preparation is transferred to each of 3 vials. To each vial is added 1 μL 0.7 M Bis-Tris pH 6.5 buffer and 1 μL 1/10th dilution of TCEP (Pierce, Rockford, Ill.), the vials are vortexed to mix and incubated at 30° C. for 1 hour, and then placed at 4° C. overnight. Compounds IVa, IVb, and a mixture of IVa and IVb (0.5 mg each) are each reconstituted with 5.6 μL DMSO. To each protein sample is added 1.5 μL of the respective compound and incubated for 1 hour at 30° C. The samples are diluted with 100 μL sample loading buffer subjected to electrophoresis on a 12% polyacrylamide gel by loading either 5 μL or 1 μL per well, and the gel imaged on a ProXPRESS Proteomic Imaging System (PerkinElmer Life Sciences, Boston, Mass.). As shown in FIG. 3, the intensity of the bands shows that isomer IVa yields far more fluorescence than isomer IVb.

### EXAMPLE 21

### Labeling and 2D electrophoresis of yeast lysate with sulforhodamine 101,2-sulfonamido-1-n-pentyl-3-bromoacetamide

Yeast lysate is prepared as follows: 50 mg of Bakers' yeast is mixed with 50 μl 9 M urea, 50 mM sodium acetate pH 5.0, 10 mM EDTA; 500 μl 20% CHAPS, 8.25 M urea; 6.25 μl Protease Inhibitor Cocktail Set III (Calbiochem, San Diego, Calif.); 50 μl TCEP (Pierce Biotechnology Inc., Rockford, Ill.) diluted 1/10. The mixture is vortexed for 1 minute and then agitated for 1 hour at ambient temperature. It is then centrifuged for 5 minutes at 16,000×g at ambient temperature. The supernatant is removed and stored at −80° C.

Yeast lysate (50 μl, 100 μg) is treated with Bond-Breaker TCEP (Pierce Biotechnology Inc., Rockford, Ill.) and incubated with 5 μl 1.0 M BisTris HCl buffer, pH 6.5 and 10 μl (1 μmole in DMSO) of 1H,5H,11H,15H— Xantheno[2,3,4-ij:5,6,7-i′j′]diquinolizin]-18-ium, 9-[4-[[[5-[(bromoacetyl)amino]pentyl]amino]sulfonyl]-2-sulfophenyl]-2,3,6,7,12,13,16,17-octahydro-, inner salt (sulforhodamine101,2-sulfonamido-1-n-pentyl-3-bromoacetamide) and incubated for 60 min. at 30° C. Following the incubation, 1 μmole mercaptoethanesulfonic is added and incubated for 30 minutes at 30° C.

IPG strip rehydration buffer (8 M Urea, 2% CHAPS, 0.01 M DTT, 2% IPG Buffer (Amersham Biosciences, Piscataway, N.J.), 0.01% Bromophenol Blue is added to the lysate and a 24 cm pH 4-7 IPG strip is rehydrated in the mixture overnight at ambient temperature. The sample is then subjected to isoelectric focusing at 103,000 volt hours, 6,000 maximum volts.

Following isoelectric focusing, strips are equilibrated two times 15 min. each in 6 M Urea, 15% glycerol, 1×NuPAGE LDS sample buffer (Invitrogen, Carlsbad, Calif.), 20 mM mercaptoethanesulfonic acid. The second dimension gel is cast in 24 cm Ettan II low fluorescence glass plates (Amersham Biosciences, Piscataway, N.J.) using 12% (w/v) acrylamide and 0.32% (w/v) bisacrylamide. The electrode buffer for the second dimension gel is the NuPAGE pre-cast mini-gels buffer (Invitrogen).

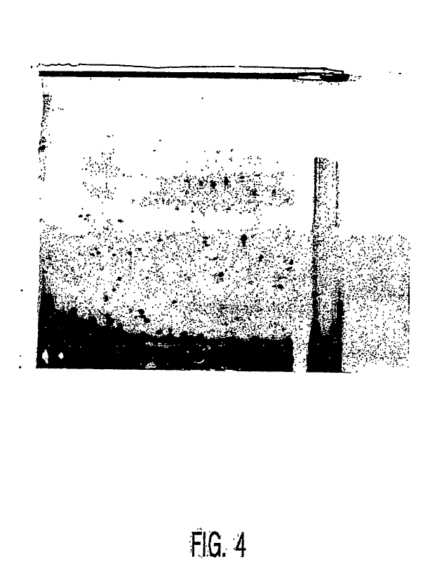

The isoelectric focusing strip is placed on top of the second dimension gel and the sample is subjected to electrophoresis in the second dimension at 2 watts per gel, 600 volts maximum for 15½ hours followed by 12.5 watts per gel, 600 volts maximum for 5½ hours. The gel is then imaged with a ProXPRESS Proteomic Imaging System (PerkinElmer Life and Analytical Sciences, Boston, Mass.) as shown in FIG. 4.

The patents and publications cited herein are indicative of the level of skill in the art to which the invention pertains. These patents and publications are herein incorporated by reference to the same extent as if each was individually and specifically incorporated by reference.

One skilled in the art will readily appreciate modifications and variations to the invention as described herein without departing from the spirit of the invention. The examples, procedures and specific compounds described herein are presently representative of preferred embodiments, are exemplary and are not intended as limitations on the scope of the invention defined by the appended claims.

1. A process for performing two-dimensional protein electrophoresis comprising:
pre-labeling a mixture containing at least one protein with a dye having a net neutral charge or no charge, said protein being pre-labeled by coupling to a protein linker group of said dye to form a pre-labeled protein; and
separating said pre-labeled protein from said mixture under two-dimensional electrophoretic conditions.

2. The process of claim 1 wherein said dye has a neutral charge.

3. The process of claim 2 wherein said dye has an equal number of quaternary amine and free sulfonate groups.

4. The process of claim 1 wherein said dye is 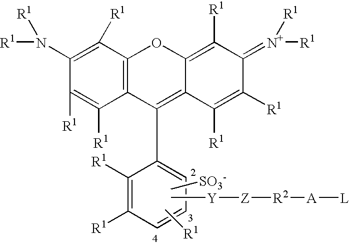
where Y is sulfonyl halide, SO₂—, or a nullity; Z is NR³— or a nullity; where each occurrence of R¹ independently is hydrogen, C₁-C₃₀ alkyl group, a C₀-C₄ alkyl group having a substituent selected from a group consisting of sulfonate, hydroxyl, sulfhydryl, substituted amine and quaternary amine and any two proximal R¹ groups are fused to form a ring structure, the ring structure optionally having a heteroatom therein and having pendant groups extending therefrom, the pendant groups each independently selected from hydrogen, C₁-C₈ alkyl, a C₀-C₄ alkyl group having a substituent selected from a group consisting of sulfonate, hydroxyl, sulfhydryl, substituted amine and quaternary amine; where R³ is H, a monocyclic aliphatic hydrocarbon, a carbohydrate, C₁-C₆ alkyl or C₁-C₆ acyl; R² is a nullity, monocyclic aliphatic hydrocarbon, a carbohydrate, an aryl, an alkyl chain of the form (CH₂)ₘ where m is an integer inclusively between 1 and 12, a polyalkylene glycol chain of the form R⁴((CH₂)ₙO)ₒR⁴ where n is an integer inclusively between 1 and 6, where o is an integer inclusively between 1 and 4, where each occurrence of R⁴ independently is C₁-C₆ alkyl or a nullity, and inert substituent containing derivatives of R² where the inert substituent is selected from a group consisting of C₁-C₆ alkyl, carbonyl, amine and sulfhydryl, or a nullity, where A is NR³— or a nullity, where at least one of the groups Y, Z, R² and A is other than the nullity, and where L is a protein linker group.

5. The process of claim 1 wherein said dye is
where each of R⁵, R⁶, R⁷ and R⁸ independently is H or C₁-C₆ alkyl, and where L is a protein linker group.

6. The process of claim 1 wherein separation involves a first dimensional electrophoretic isoelectric focusing.

7. The process of claim 6 further comprising introducing a reagent prior to the first dimensional electrophoretic isoelectric focusing to clear said dye that is independent of said pre-labeled protein.

8. The process of claim 1 wherein said dye is isomerically purified.

9. The process of claim 4 wherein L is an electrophilic moiety.

10. The process of claim 4 wherein L is haloacetamide and A is NR³—.

11. The process of claim 4 wherein L is acid halide, C₁-C₁₂ ester, acyl azide, pyridyl disulfide, haloacetamide, maleimide, maleimidyl benzamide, maleimidyl C₁-C₅ alkylamido, azidobenzamide, azidoperfluorobenzamido, and where a halide or halo moiety is Cl, Br or I.

12. The process of claim 4 wherein L is haloacetamide.

13. The process of claim 4 wherein SO₃⁻ is bonded at phenyl position 2 and Y-Z-R²-A-L is bonded at phenyl position 4.

14. The process of claim 4 wherein SO₃⁻ is bonded at phenyl position 4 and Y-Z-R²-A-L is bonded at phenyl position 2.

15. The process of claim 5 wherein L is an electrophilic moiety.

16. The process of claim 5 wherein L is haloacetamide and A is NR³—.

17. The process of claim 5 wherein L is acid halide, C₁-C₁₂ ester, acyl azide, pyridyl disulfide, haloacetamide, maleimide, maleimidyl benzamide, maleimidyl C₁-C₅ alkylamido, azidobenzamide, azidoperfluorobenzamido, and where a halide or halo moiety is Cl, Br or I.

18. The process of claim 5 wherein L is haloacetamide.

19. The process of claim 5 wherein SO₃⁻ is bonded at phenyl position 2 and Y-Z-R²-A-L is bonded at phenyl position 4.

20. The process of claim 5 wherein SO₃⁻ is bonded at phenyl position 4 and Y-Z-R²-A-L is bonded at phenyl position 2.

21. A compound of the formula 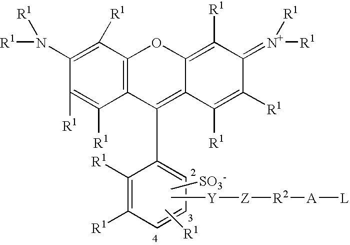
where Y is SO₂—, where Z is NR³—, where each occurrence of R¹ independently is hydrogen, C₁-C₃₀ alkyl group, a C₀-C₄ alkyl group having a substituent selected from a group consisting of sulfonate, hydroxyl, sulfhydryl, substituted amine and quaternary amine and any two proximal R¹ groups are fused to form a ring structure, the ring structure optionally having a heteroatom therein and having pendant groups extending therefrom, the pendant groups each independently selected from hydrogen, C₁-C₈ alkyl, a C₀-C₄ alkyl group having a substituent selected from a group consisting of sulfonate, hydroxyl, sulfhydryl, substituted amine and quaternary amine; where R³ is H, a monocyclic aliphatic hydrocarbon, a carbohydrate, C₁-C₆ alkyl or C₁-C₆ acyl, where R² is a nullity, a monocyclic aliphatic hydrocarbon, a carbohydrate, a polyalkylene glycol chain of the form R⁴((CH₂)ₙO)ₒR⁴ where n is an integer inclusively between 1 and 6, where o is an integer inclusively between 1 and 4, where each occurrence of R⁴ independently is C₁-C₆ alkyl or a nullity, and inert substituent containing derivatives of R² where the inert substituent is selected from a group consisting of C₁-C₆ alkyl, carbonyl, amine and sulfhydryl, where A is NR³—, and where L is a protein linker group.

22. The compound of claim 21 wherein R³ is H.

23. The compound of claim 21 wherein R² is R₄(CH₂CH₂O)ₙR₄.

24. The compound of claim 23 wherein R² is CH₂(CH₂CH₂O)ₒ(CH₂)₃.

25. The compound of claim 21 wherein SO₃⁻ is bonded at phenyl position 2 and Y-Z-R²-A-L is bonded at phenyl position 4.

26. The compound of claim 21 wherein SO₃⁻ is bonded at phenyl position 4 and Y-Z-R²-A-L is bonded at phenyl position 2.

27. The compound of claim 21 wherein L is an electrophilic moiety.

28. The compound of claim 21 wherein L is acid halide, C₁-C₁₂ ester, acyl azide, pyridyl disulfide, haloacetamide, maleimide, maleimidyl benzamide, maleimidyl C₁-C₅ alkylamido, azidobenzamide, azidoperfluorobenzamido, and where a halide or halo moiety is Cl, Br or I.

29. The compound of claim 21 wherein L is haloacetamide.

30. A compound of the formula 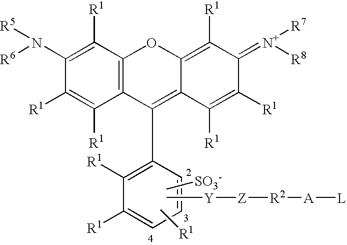
where Y is SO₂—, where Z is NR³—, where each occurrence of R¹ independently is hydrogen, C₁-C₃₀ alkyl group, a C₀-C₄ alkyl group having a substituent selected from a group consisting of sulfonate, hydroxyl, sulfhydryl, substituted amine and quaternary amine and any two proximal R¹ or R¹ and one of R⁵, R⁶, R⁷ or R⁸ groups are fused to form a ring structure, the ring structure optionally having a heteroatom therein and having pendant groups extending therefrom, the pendant groups each independently selected from hydrogen, C₁-C₈ alkyl, a C₀-C₄ alkyl group having a substituent selected from a group consisting of sulfonate, hydroxyl, sulfhydryl, substituted amine and quaternary amine; where R³ is H, a monocyclic aliphatic hydrocarbon, a carbohydrate, C₁-C₆ alkyl or C₁-C₆ acyl, where R² is a nullity, a monocyclic aliphatic hydrocarbon, a carbohydrate, a polyalkylene glycol chain of the form R⁴((CH₂)ₙO)ₒR⁴ where n is an integer inclusively between 1 and 6, where o is an integer inclusively between 1 and 4, where each occurrence of R⁴ independently is C₁-C₆ alkyl or a nullity, and inert substituent containing derivatives of R² where the inert substituent is selected from a group consisting of C₁-C₆ alkyl, carbonyl, amine and sulfhydryl, where A is NR³—, or a nullity where at least one of the groups Y, Page 11 of 15 Z, R² and A is other than the nullity, where each of R⁵, R⁶, R⁷ and R⁸ independently is H or C₁-C₆ alkyl, and where L is a protein linker group.

31. The compound of claim 30 wherein R³ is H.

32. The compound of claim 30 wherein R² is R₄(CH₂CH₂O)ₙR₄.

33. The compound of claim 32 wherein R² is CH₂(CH₂CH₂O)ₙ(CH₂)₃.

34. The compound of claim 30 wherein SO₃⁻ is bonded at phenyl position 2 and Y-Z-R²-A-L is bonded at phenyl position 4.

35. The compound of claim 30 wherein SO₃⁻ is bonded at phenyl position 4 and Y-Z-R²-A-L is bonded at phenyl position 2.

36. The compound of claim 30 wherein L is an electrophilic moiety.

37. The compound of claim 30 wherein L is acid halide, C₁-C₁₂ ester, acyl azide, pyridyl disulfide, haloacetamide, maleimide, maleimidyl benzamide, maleimidyl C₁-C₅ alkylamido, azidobenzamide, azidoperfluorobenzamido, and where a halide or halo moiety is Cl, Br or I.

38. The compound of claim 30 wherein L is haloacetamide.

39. An improved method of performing two-dimensional protein electrophoresis, where a mixture contains a protein, the protein is partially separated from the mixture by a one-dimensional electrophoretic process wherein the improvement lies in: pre-labeling the protein with an isomerically purified dye.

40. The improved method of claim 39 wherein said isomerically purified dye is a dye having a neutral or no charge.

41. The improved method of claim 40 wherein said neutral dye contains an equal number of quaternary amine and free sulfonate groups.

42. The improved method of claim 39 wherein said isomerically purified dye is a compound of claim 21.

43. The improved method of claim 39 wherein said isomerically purified dye is a compound of claim 30.

44. A commercial package comprising a compound of claim 21 as an active ingredient together with instructions for the use thereof as a protein labeling dye.

45. A commercial package comprising a compound of claim 30 as an active ingredient together with instructions for the use thereof as a protein labeling dye.

46. Use of a compound of claim 21 for labeling a protein.

47. Use of a compound of claim 30 for labeling a protein.

48. A compound of claim 21 substantially as described herein in any of the examples.

49. A compound of claim 30 substantially as described herein in any of the examples.

50. The process of claim 1 wherein the said dye contains a cleavable moiety.

51. The compound of claim 21 wherein at least one of the groups Z, R¹, R² and A contains a cleavable moiety. 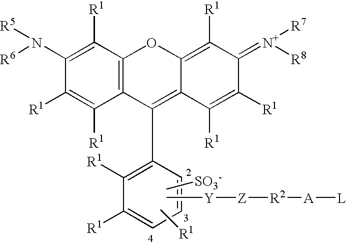
where Y is sulfonyl halide, SO₂—, or a nullity; Z is NR³— or a nullity; where each occurrence of R¹ independently is hydrogen, C₁-C₃₀ alkyl group, a C₀-C₄ alkyl group having a substituent selected from a group consisting of sulfonate, hydroxyl, sulfhydryl, substituted amine and quaternary amine and any two proximal R¹ or R¹ with one of R⁵, R⁶, R⁷ or R⁸ groups are fused to form a ring structure, the ring structure optionally having a heteroatom therein and having pendant groups extending therefrom, the pendant groups each independently selected from hydrogen, C₁-C₈ alkyl, a C₀-C₄ alkyl group having a substituent selected from a group consisting of sulfonate, hydroxyl, sulfhydryl, substituted amine and quaternary amine; where R³ is H, a monocyclic aliphatic hydrocarbon, a carbohydrate, C₁-C₆ alkyl or C₁-C₆ acyl; R² is a nullity, a monocyclic aliphatic hydrocarbon, a carbohydrate, an aryl, an alkyl chain of the form (CH₂)ₘ where m is an integer inclusively between 1 and 12, a polyalkylene glycol chain of the form R⁴((CH₂)ₙO)ₒR⁴ where n is an integer inclusively between 1 and 6, where o is an integer inclusively between 1 and 4, where each occurrence of R⁴ independently is C₁-C₆ alkyl or a nullity, and inert substituent containing derivatives of R² where the inert substituent is selected from a group consisting of C₁-C₆ alkyl, carbonyl, amine and sulfhydryl, or a nullity all, where A is NR³— or a nullity where at least one of the groups Y, Z, R² and A is other than the nullity,
